(19) United States
(12) Patent Application Publication
(10) Pub. No.: US 2026/0006081 A1
(43) Pub. Date: Jan. 1, 2026

(54) CORRELATION OF MACHINE LEARNING MODEL GENERATED SECURITY POLICY TO INPUT FEATURES

(71) Applicant: HEWLETT PACKARD ENTERPRISE DEVELOPMENT LP, Spring, TX (US)

(72) Inventors: Gopal Gupta, Bangalore (IN); Satishwar Chandrashekar, Bangalore (IN)

(21) Appl. No.: 18/819,481

(22) Filed: Aug. 29, 2024

(30) Foreign Application Priority Data
Jun. 27, 2024 (IN) 202441049332

(51) Int. Cl. H04L 9/40

(52) U.S. Cl. CPC H04L 63/20; H04L 63/1425

(57) ABSTRACT

In some examples, an authorization controller includes a machine learning model to manage access control to a network environment by a client device based on input features to the machine learning model, the input features including user information of a user of the client device, device information representing the client device, and network information representing a network used by the client device. The machine learning model when executed by the authorization controller generates a security policy used by the authorization controller in managing the access control. A system can correlate the security policy to model parameters set by the machine learning model in generating the security policy, and use the correlation to indicate which of the input features contributed to the security policy generated by the machine learning model.

### BACKGROUND

Networks implement security measures to protect against unauthorized access of the networks and malicious actions against resources accessible over the networks. In some cases, a network can implement a zero trust security system that seeks to authenticate and authorize, based on a security policy, every device, connection, and data flow in the network.

### BRIEF DESCRIPTION OF THE DRAWINGS

Some implementations of the present disclosure are described with respect to the following figures.

FIG. 1 is a block diagram of an arrangement including a network access authorization controller and a security policy explanation engine, in accordance with some examples.

FIG. 2 is a graph depicting attention weights assigned to input features of a machine learning model, and a strictness measure representing a strictness of a security policy generated by the machine learning model, in accordance with some examples.

FIG. 3 is a block diagram of a system according to some examples.

FIG. 4 is a block diagram of a storage medium storing machine-readable instructions according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Users of a network may be located at different places. Some users may connect to the network in a protected environment, such as in an office or at other facilities of an enterprise. Other users may be located remotely from the protected environment, and these other users may connect to the network over an unsecure network, such as the Internet or any other network not operated by the enterprise. Remote users that connect to the network may raise potential security issues. For example, connections of client devices belonging to the remote users to the network may be less secure and thus may be more easily attacked. In addition, behaviors of users may change, which may affect the security posture of the users. For example, users can connect to the network using different client devices at different times. The different client devices may have different security mechanisms, such as different malware protection programs. Users may also move around and connect to the network from different locations; some locations may be less secure than others. Additionally, other characteristics relating to users, client devices, networks, and programs may also change over time, which can raise different security concerns.

A security system, such as a zero trust security system, implemented to manage access of a network may rely on the use of a static security policy that does not change, or that changes infrequently. The security policy may remain constant even as characteristics relating to users, client devices, networks, and programs change. The changed characteristics may cause the security policy to be too lenient or too strict. A lenient security policy can result in the security mechanism not being able to detect certain security issues, which can lead to data theft and attacks over the network. A strict security policy can result in the security mechanism reporting a false positive, which includes a security alert when in fact a security issue does not exist. A false positive can trigger remediation actions that are disruptive to operations while the purported security issue is being investigated.

In accordance some examples of the present disclosure, a security system uses a machine learning model to dynamically adjust a security policy in response to changing conditions corresponding to changes in characteristics relating to users, client devices, networks, and/or programs. The dynamic adjustment of the security policy allows for the security policy to adapt to the changing conditions, so that a more lenient security policy may be applied when less security concerns are predicted, and a stricter security policy may be applied when greater security concerns arise. A challenge associated with the use of machine learning models in security systems is that it may be difficult to determine the underlying reasons behind why the machine learning models produced their outputs. In accordance with some implementations of the present disclosure, a model explanation system can be used to provide explanation information regarding the underlying factors that led to a machine learning model producing its output. The output of the machine learning model may be a recommended security policy that is based on input features provided to the machine learning model. The model explanation system can correlate the recommended security policy to model parameters set by the machine learning model in generating the recommended security policy. In an example, if the machine learning model is a transformer model, then the model parameters may include attention weights of an attention function in the transformer model. The model explanation system can use the correlation to indicate which of the input features contributed (e.g., made the greatest contribution or contributions) to the recommended security policy produced by the machine learning model.

A security policy specifies security controls that are applied to access requests for accessing a network environment. An access request can include a control message that is transmitted by a requester (e.g., a user, a program, or a machine) to connect to the network environment. In other examples, an access request can include a data packet transmitted by the requester that is to reach a recipient in the network environment.

In some examples, the security controls specified by the security policy may be implemented at multiple different levels. For example, the different levels can include an operating system (OS) level, a network level, a cryptography level, and an application level. Although reference is made to specific example levels of a security policy, it is noted that other examples can use other categories of security controls. The OS level of the security policy includes security controls based on one or more of the following: isolation of requesters based on privileges of the requesters, separation of requesters based on capabilities of the requesters, entropies of random number generators provided by OSes, or other controls associated with an OS.

The network level of the security policy includes one or more of the following security controls: an intrusion detection and prevention (IDPS) control (e.g., which can be set to any of various values to represent different levels of IDPS protection to prevent intrusions of unauthorized entities into a network environment), anti-malware control (e.g., which can be set to any of various values to represent different levels of protection against malware), data loss prevention (DLP) (e.g., which can be set to any of various values to represent different levels of DLP to protect against data loss), firewall protection (e.g., which can be set to any of various values to represent different levels of firewall protection), admission control (e.g., Wi-Fi Multimedia (WMM) admission control according to the Institute of Electrical and Electronics Engineers (IEEE) 802.11e standard), bandwidth control (that controls how much bandwidth can be used by a device), Internet Protocol Address Management (IPAM) control, content inspection of data packets (e.g., deep packet inspection or inspection of header of packets), Secure Sockets Layer (SSL) validation, Domain Name System (DNS) security control, Dynamic Host Configuration Protocol (DHCP) security control, certificate validation, inspection of uniform resource locators (URLs), use of a secured transport protocol (e.g., the Mutual Transport Layer Security (mTLS) protocol, the Datagram Transport Layer Security (DTLS) protocol, or any other secured transport protocol), or other controls relating to communications over a network.

The cryptography level of the security policy includes use of one or more algorithms or protocols to perform cryptographic operations, such as encrypting information, signing information, provide read-only or read-write access to requesters, or other controls relating to security information when communicated.

The application level of the security policy includes access control such as by using access control lists (ACLs) for application programs, use of audit logs to record activities of application programs, or other controls associated with application programs.

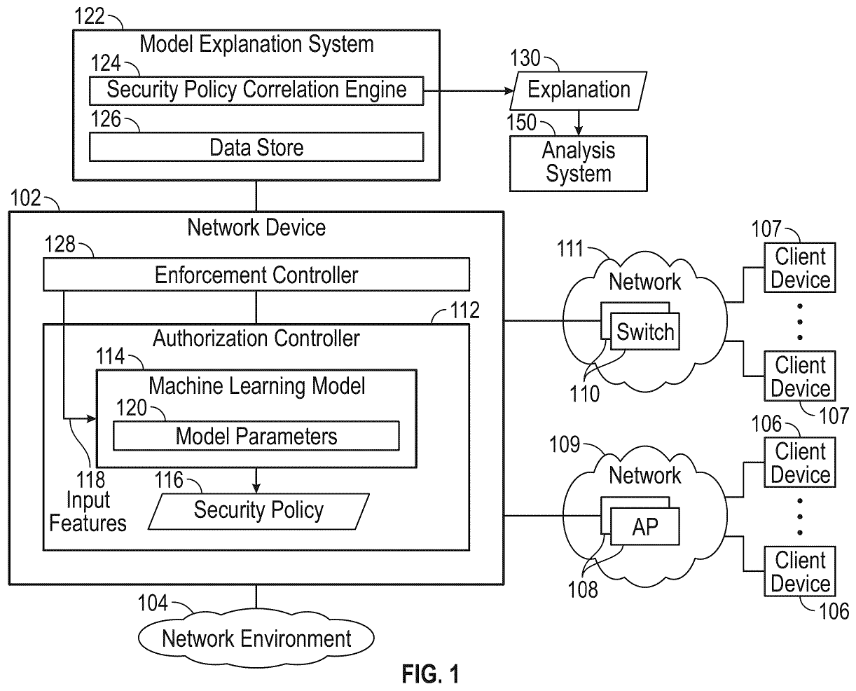

FIG. 1 is a block diagram of an example arrangement that includes a network device 102 that manages access of a network environment 104 by client devices 106 and 107. The network environment 104 includes one or more protected networks, such as local area networks (LANs), wide area networks (WANs), or other types of networks, to which various resources are connected. Examples of resources include machines, programs, data repositories, and/or other resources.

The client devices 106 may be wirelessly connected to wireless access points (APs) 108 of a network 109, and the client devices 107 may be connected (by wired connections) to switches 110 of a network 111. The networks 109 and 111 are relatively unsecure networks (e.g., less secure than a network in the network environment 104). Although two relatively unsecure networks 109 and 111 are shown in FIG. 1, it is noted that in other examples, there may be less than two or more than two relatively unsecure networks.

The network device 102 may be an edge device that controls whether or not a client device (e.g., 106 or 107) outside the network environment 104 is permitted to access the network environment 104. In some examples, the network device 102 includes an authorization controller 112 and an enforcement controller 128. Generally, the authorization controller 112 and the enforcement controller 128 cooperate to manage access to the network environment 104. In other examples, the functionalities of the authorization controller 112 and the enforcement controller 128 may be combined into a single controller. In further examples, the functionalities of the authorization controller 112 and the enforcement controller 128 may be separated into more than two controllers.

The authorization controller 112 and the enforcement controller 128 form a security system that manages access of the network environment 104. In other examples, the authorization controller 112 and the enforcement controller 128 may be provided outside the network device 102. For example, the authorization controller 112 and the enforcement controller 128 can be provided for use with multiple network devices for managing access of one or more network environments.

The enforcement controller 128 receives an access request, such as from a client device 106 or 107. The enforcement controller 128 forwards the access request to the authorization controller 112. The enforcement controller 128 can also generate the input features 118 for the access request, and provides the input features 118 to the authorization controller 112 for approval of the access request.

The authorization controller 112 can perform functions of a policy engine and a trust engine. The trust engine evaluates the access request. In some examples, the trust engine computes dynamic trust scores using a machine learning model 114. Based on the trust scores the machine learning model 114 generates a security policy 116 based on which the policy engine of the authorization controller 112 determines whether to approve the access request for accessing the network environment 104. If the policy engine of the authorization controller 112 approves the access request, the authorization controller 112 sends an approve indication (e.g., a signal, a message, an information element, or another indicator) to the enforcement controller 128 indicating that the access request is approved. Based on the approve indication, the enforcement controller 128 grants the access request.

If the policy engine denies the access request based on the security policy 116 generated by the machine learning model 114, the authorization controller 112 sends a deny indication to the enforcement controller 128 indicating that the access request has been denied. Based on the deny indication, the enforcement controller 128 denies the access request.

The machine learning model 114 dynamically generates the security policy 116 based on input features 118 received by the machine learning model 114. In some examples, the input features 118 are generated by the enforcement controller 128 and provided to the authorization controller 112. In some examples, the machine learning model 114 is able to assign trust labels (representing trust scores) based on values of the input features 118. For example, the trust labels can include high (indicating a high trust score), medium (indicating a medium trust score), and low (indicating a low trust score). In other examples, the machine learning model 114 is able to generate trust labels representing numerical trust scores. Based on the trust labels, the machine learning model 114 produces the security policy 116, such as a lenient security policy for the high trust score, a medium security policy for the medium trust score, and a strict security policy for the low trust score.

More generally, the security policy 116 is dynamically changed by the machine learning model 114 as values of the input features 118 change. In some examples, the input features 118 can include features representing user information of a user of a client device (e.g., 106 or 107), features representing device information of the client device, features representing network information of a network (e.g., 109 or 111) to which the client device is connected, and/or other features (discussed further below).

Based on the input features 118, the machine learning model adjusts internal model parameters 120 of the machine learning model 114 as part of the operation of the machine learning model 114. In some examples, the machine learning model 114 produces a trust label for an access request based on the values of the model parameters 120. Using the trust label, the machine learning model 114 generates a corresponding security policy.

In some examples, the machine learning model 114 is a transformer model, which is a type of neural network-based machine learning model. The transformer model uses a multi-head attention mechanism to compute attention weights. In examples where the transformer model is used in the authorization controller 112, the model parameters 120 include the attention weights. The attention mechanism is used to compute the importance, or attention weight, of each input feature 118 relative to other input features. The attention mechanism calculates the attention weights dynamically for each input feature based on the relevance of the input feature to the current context associated with the access request being considered by the authorization controller 112.

The following provides a brief discussion of how an example transformer model operates. Each input feature 118 (also referred to as a “token”) is associated with three vectors: query (Q), key (K), and value (V). These vectors are learned during training of the transformer model and represent different aspects of the input feature's representation. For each input feature 118 (“current input feature”), the attention mechanism calculates an attention score by taking a dot product of the query vector (Q) of the current input feature with the key vector (K) of every other input feature. The dot product results in a set of scores representing how much focus the current input feature should receive. The attention scores are then passed through a softmax function to convert the attention scores into attention weights, ensuring that the attention weights sum up to 1. A softmax function converts a vector of values (e.g., attention scores) into a vector of probabilities (e.g., attention weights). The attention weights determine the importance of respective input features for the current input feature being processed. The attention weights are used to compute a weighted sum of the value vectors (V) of all input features 118. The weighted sum represents the attended representation of the current input feature, incorporating information from other input features based on their importance as determined by the attention mechanism.

In the multi-head attention mechanism, the above process is performed multiple times (multiple “attention heads”) in parallel with different sets of learnable model parameters 120, allowing the transformer model to attend to different aspects of the input simultaneously. The outputs of these multiple attention heads can be concatenated and linearly transformed to produce a final output of the multi-head attention mechanism.

Although reference is made to use of a transformer model in some examples, in other examples, other types of neural network-based models, or more generally, other types of machine learning models, may be employed in the authorization controller 112. Generally, the machine learning model 114 may be trained (using supervised and/or unsupervised learning) to generate outputs based on training data sets. The machine learning model is trained to produce security policies based on various collections of input features.

In accordance with some examples of the present disclosure, a model explanation system 122 is coupled to the network device 102. The model explanation system 122 can be implemented using one or more computers. In some examples, the model explanation system 122 is separate from the security system including the authorization controller 112 and the enforcement controller 128. In other examples, the model explanation system 122 may be part of the security system.

The model explanation system 122 is able to obtain information associated with the authorization controller 112, including the input features 118, the model parameters 120, and the generated security policy 116. The input features 118, the model parameters 120, and the generated security policy 116 can be stored in a data store 126 of the model explanation system 122. The data store 126 can include a database or any other data repository to store information. The data store 126 can be stored in one or more storage devices.

The model explanation system 122 includes a security policy correlation engine 124 that correlates the predicted security policy 116 to the model parameters 120 set by the machine learning model 114 in generating the security policy 116. The security policy correlation engine 124 uses the correlation (between the security policy 116 and the model parameters) to indicate which of the input features 118 contributed to the security policy 116 generated by the machine learning model 114. More specifically, the security policy correlation engine 124 can identify a subset (less than all) of the input features 118 with the higher contributions to the security policy 116 as compared to a remainder of the input features 118. A subset of the input features 118 can include a single input feature or multiple input features. The remainder includes one or more input features 118 that are not part of the identified subset.

The identified subset of the input features 118 is included as part of explanation information 130 generated by the security policy correlation engine 124. The model explanation system 122 can send the explanation information 130 to a target entity, such as a human user, a program, or a machine.

In accordance with some examples of the present disclosure, the machine learning model 114 is able to consider a current dynamic condition represented by the input features 118 to dynamically generate the security policy 116. Further, the model explanation system 122 provides explainability of the machine learning model 114 using the model parameters 120 set by the machine learning model 114, where the explainability includes identifying the subset of the input features 118 with the higher contributions to the security policy 116.

In some examples, explainability (as represented by the explanation information 130) can improve security operations by providing further insight regarding various security aspects. Generally, by incorporating explainability into network security policies and enforcement mechanisms, techniques or mechanisms according to some examples of the present disclosure can improve anomaly detection, access control, intrusion detection and prevention, incidence response, compliance, and user awareness, ultimately enhancing the overall security posture of networks.

For anomaly detection, explainability can provide information regarding why certain network activities or behaviors are flagged as anomalous. By providing insights into the specific criteria or rules that triggered the detection, a target entity receiving the explanation information 130 can better assess the severity and potential impact of detected anomalies.

Further, for access control, explainability can clarify why certain users or devices are granted or denied access to network resources. This transparency helps ensure that access control decisions (of the authorization controller 112) align with organizational policies and regulatory requirements.

For intrusion detection and prevention, when an intrusion is detected or prevented by security measures, explainability can shed light on the underlying reasons for the action taken. A target entity receiving the explanation information 130 can review the decision-making process to identify the specific indicators or signatures of the intrusion and understand how the intrusion was detected.

For policy violation analysis, if a network security policy is violated, explainability can provide insights into the reasons behind the violation. This includes identifying which policy rules were violated, the context in which the violation occurred, and the potential implications for the security system.

For threat intelligence integration, explainability can be used to correlate security events with external threat intelligence sources. By explaining how threat intelligence data influenced security decisions, organizations can better understand emerging threats and prioritize their response efforts accordingly.

For incidence response and forensics, during incident response and forensic investigations, explainability helps reconstruct the sequence of events leading up to a security incident. A target entity receiving the explanation information 130 can trace the actions of threat actors, identify the attack vectors used, and understand the impact on the network infrastructure.

For compliance reporting, explainability supports compliance reporting by providing a clear rationale for security decisions and actions taken within the network environment. Organizations can demonstrate adherence to regulatory requirements and industry standards by documenting the explainable nature of their security measures.

For user education and awareness, explainability can be leveraged to educate users and raise awareness about security best practices. By explaining the reasons behind certain security policies and restrictions, organizations can empower users to make informed decisions and contribute to a culture of security.

For root cause analysis, when a security incident occurs, understanding the root cause is essential for an effective response. This can expedite mitigation and improve future prevention strategies.

For security policy creation, explainability can help security teams understand how different factors in a security policy contribute to its overall effect. This allows for more precise and targeted security policy creation, reducing the risk of unintended consequences or loopholes.

For debugging and optimization, when a policy engine makes a decision, explainability tools can highlight the reasoning behind the decision. This allows security teams to identify and fix inconsistencies or inefficiencies within the security policy.

### Input Features

The following describes examples of the input features 118 that can be derived for an access request. Although example input features are provided, it is noted that in other examples, some of the example input features may be omitted and other input features may be added.

The enforcement controller 128 receives the access request (e.g., a control message or a data packet), and the enforcement controller 128 derives various characteristics based on the access request. The derived characteristics can be based on ACLs, authentication policies, deep packet inspection, security rules, network data, and/or other information.

Example input features representing user characteristics (characteristics of a user of a client device, for example) are set forth in Table 1 below. More generally, such user characteristics are referred to as user information. These input features are part of a user information input vector.

TABLE 1

| | | Distance of the | Nearest physical | | |
|---|---|---|---|---|---|
| | | user from an | location from | | |
| | Distance from | access device | where frequent | | |
| | previous login | such as an AP or | active connections | Authorization | Bandwidth |
| Feature | location | network switch | are observed | technique | usage pattern |
| Description | Normalized | Normalized | Normalized | A label representing | User score |
| | distance: “1” | distance | distance | the authorization | based on |
| | means farthest | | | technique used | bandwidth |
| | and “0” means | | | (e.g., multi-factor | consumption |
| | nearest | | | authentication, | |
| | | | | password, etc.) | |

Input features representing device characteristics (of a client device) are set forth in Table 2 below. More generally, such device characteristics are referred to as device information. These input features are part of a device information input vector.

TABLE 2

| Feature | Manufacturer | Host OS | HSM | Deployment | TPM |
|---|---|---|---|---|---|
| Description | Reputation of | Manufacturer, | Manufacturer, | Nature of deployment | Manufacturer, |
| | the manufacturer | version, and | version, and | of an application | version, and |
| | of the client | security score | vulnerability | used by the client | vulnerability |
| | device | of the host | score of a | device (e.g., cloud | score of a |
| | | OS in the | hardware security | application, internal | trusted platform |
| | | client device | module (HSM) in | application in the | module (TPM) |
| | | | the client device | client device, on- | in the client |
| | | | | premise application, | device |
| | | | | network application, etc.) | |

Input features representing program characteristics (of a program running in a client device) are set forth in Table 3 below. More generally, such program characteristics are referred to as program information. These input features are part of a program information input vector.

TABLE 3

| Feature | Website category | Web score | Program category | Reputation |
|---|---|---|---|---|
| Description | A category of a | Normalized | A category of a | A network |
| | website supported | score based on | program, which can | reputation |
| | by a program, such | web browsing | be assigned based | score based on |
| | as a news website, | history | on the type of | geolocation of |
| | a social website, a | | resource accessed, | the program |
| | sports website, etc. | | an assigned IP | |
| | | | address, and an | |
| | | | assigned classification | |

Input features representing network characteristics (of a network from which an access request is received from a requester) are set forth in Table 4 below. More generally, such network characteristics are referred to as network information. These input features are part of a network information input vector.

TABLE 4

| | | | Network | |
|---|---|---|---|---|
| Feature | IP address | Network health | Security Score | Network tagging |
| Description | IP reputation | Network health | Network | Network tag |
| | score assigned | score based on | security score | encoded based on |
| | based on the | a combination of | based on | a source role, an |
| | type of network | network integrity | network threat | application |
| | and IP | and availability | perception | program, and so |
| | addresses of | | | forth |
| | the network | | | |

Input features can also represent the historical behavior characteristics. These input features are part of a historical behavior input vector. For example, historical behavior characteristics may be based on a user trust score derived from the past activities and login patterns of a user, and/or a device trust score derived from past activities of a client device. Various techniques may be used to calculate a user or device trust score, such as techniques that employ simple scoring, weighted scoring, a machine learning based technique, or other techniques. Trust scores may be based on any or some combination of the following: user activity data, such as login attempts, purchase history, emails sent, browsing behavior, etc.; device and network data, such as an IP address, device type, login location, detected anomalies, etc.; and user profile information, such as account age, verification status, past interactions with customer support, etc.

The following provides some examples of scenarios that may indicate that stricter security policies should be predicted by the machine learning model 114. In a first scenario, a user is using an unexpected device (different from a device that the user normally uses based on historical data), not very far from a previous location of access, but far from an access device such as an AP 108 or network switch 109, at an unusual hour past midnight. The machine learning model 114 may predict a lower trust score for this first scenario that may trigger the generation of a stricter security policy.

In a second scenario, a user has accessed an unexpected resource in the network environment 104, where the unexpected resource is different from resources normally accessed by the user based on historical data. The access of the unexpected resource may be at a location that is far from an access device such as an AP 108 or network switch 110. The machine learning model 114 may predict a lower trust score for this second scenario that may trigger the generation of a stricter security policy.

In a third scenario, input features may indicate that a network breach has occurred or is about to occur (such as by malware or another attacker). malware or other security attacks). The machine learning model 114 may predict a lower trust score for this third scenario that may trigger the generation of a stricter security policy.

In a fourth scenario, a user is using an expected device (a device that the user normally uses based on historical data), not very far from a previous location of access, but far from an access device such as an AP 108 or network switch 110, to access websites that the user normally accessed based on historical data. Although the user is using an expected device not far from a previous location of access to access websites that the user normally access, the relatively large distance from the AP (which indicates that the user may be outside a secure environment) would may cause the machine learning model 114 to predict a medium trust score and thus generate a medium security policy.

In a fifth scenario, a user is using an expected device), not very far from a previous location of access, an near an access device such as an AP 108 or network switch 110, to access websites that the user normally accessed based on historical data. The machine learning model 114 may predict a higher trust score for this fifth scenario that may trigger the generation of a lenient security policy.

### Security Policy Generation

The input features 118 are provided as input to the machine learning model 114, which can produce a security policy vector that represents the security policy 116. The security policy vector includes values for respective security policy parameters representing security controls, such as those of the OS level, network level, cryptography level, and application level discussed further above. In other examples, a security policy generated by the machine learning model 114 can be represented in another form, such as in a file or any other type of object.

Table 5 below lists some example parameters of the security policy vector.

TABLE 5

| | | | | | | CRYPTO-ALGO- | VECTOR |
|---|---|---|---|---|---|---|---|
| IDPS | AM | CI | DLP | FW | . . . | CLASS | ID |
| 3 | 5 | 1 | 8 | 3 | . . . | 3 | 357833 |
| 6 | 3 | 0 | 7 | 8 | . . . | 8 | 637788 |
| 7 | 8 | 1 | 4 | 2 | . . . | 2 | 783422 |

The “IDPS” parameter (column) can be set to values representing different levels of the intrusion detection and prevention applied. The “AM” parameter (column) can be set to values representing different levels of anti-malware protection. The “CI” parameter (column) can be set to different values to represent different types of content inspection (CI). The “DLP” parameter (column) can be set to values representing different levels of data loss prevention. The “FW” parameter (column) be set to values representing different levels of firewall (FW) protection. The CRYPTO-ALGO-CLASS parameter (column) can be set to values representing different types of cryptographic algorithms used.

Each row of Table 5 represents the values of the parameters of the security policy vector at a respective point in time. The three rows in Table 5 represent values of parameters of security policy vectors at three different points in time. The “VECTOR ID” column includes an identifier assigned to the security policy vector at the respective point in time.

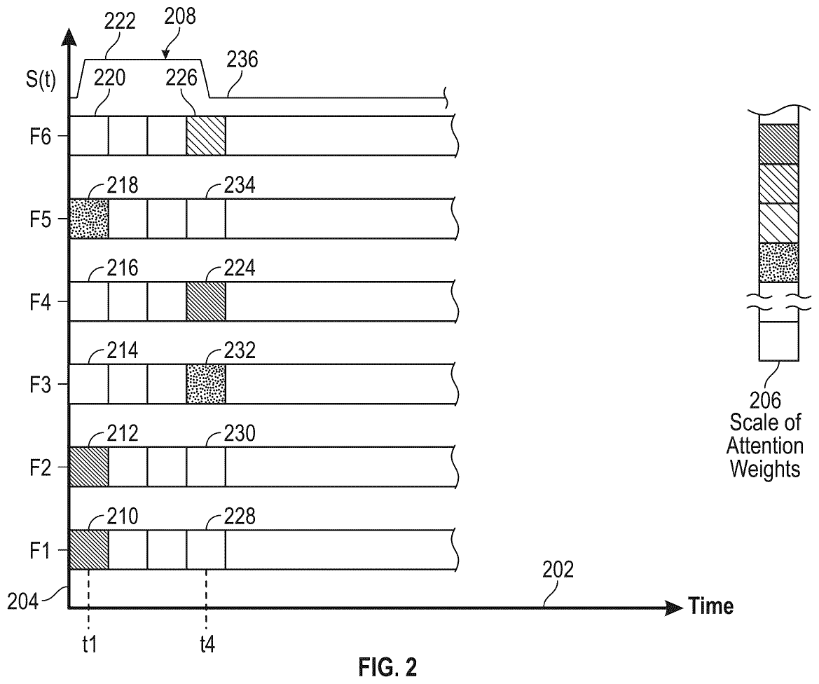

FIG. 2 below is an example graph that shows various input features F1 to F6 (which are part of the input features 118 of FIG. 1) and values of attention weights assigned to the input features at different time points. The horizontal axis 202 of the graph of FIG. 2 represents time. The vertical axis 204 represents the input features F1 to F6, and a strictness measure S(t). In the example of FIG. 2, darker shadings can represent higher attention weights than lighter shadings, as represented by a scale 206. Although six input features are depicted in FIG. 2, in other examples, a different quantity of input features may be used by the machine learning model 114.

A curve 208 represents a strictness measure S(t) representing the strictness of the security policy predicted by the machine learning model 114 as a function of time (t). In some examples, a higher value of the strictness measure S(t) represents a stricter security policy. In some examples, the strictness measure S(t) can be a probability of a strict security policy prediction. Different security policies produced by the machine learning model 114 may have different levels of strictness, from the strictest security policy to the most lenient security policy.

The security policy correlation engine 124 of the model explanation system 122 can correlate values of attention weights assigned to each input feature (F1 to F6) to the strictness, S(t), of the security policy predicted by the machine learning model 114 at time t. At time t1, input features F1 and F2 have the highest attention weights, as represented by blocks 210 and 212, respectively. The other input features F3 to F6 have lower attention weights, as represented by blocks 214, 216, 218, and 220, respectively. The correlation of the strictness of the predicted security policy at time t1 to the attention weights of input features F1 to F6 includes identifying which of the input features F1 to F6 have higher attention weights at time t1, and which other input features have lower attention weights at time t1. At time t1, a strict security policy was predicted by the machine learning model 114, based on the relatively high strictness value 222 of S(t) at time t1. Therefore, based on the correlation of the higher attention weights of input features F1, F2 at time t1 to the high strictness value 222 at time t1, the security policy correlation engine 124 can make a determination that a first subset (F1 and F2) of the input features F1 to F6 contributed more to the decision to select the stricter security policy at time t1 as compared to the remainder (F3 to F6) of the input features F1 to F6.

At time t4, input features F4 and F6 have higher attention weights, as represented by blocks 224 and 226, respectively. The other input features F1, F2, F3, and F5 have lower attention weights, as represented by blocks 228, 230, 232, and 234, respectively. The correlation of the strictness of the predicted security policy at time t4 to the attention weights of input features F1 to F6 includes identifying which of the input features F1 to F6 have higher attention weights at time t4, and which other input features have lower attention weights at time t4. At time t4, a lenient security policy was predicted by the machine learning model 114, based on the relatively low strictness value 236 of S(t) at time t4. Therefore, based on the correlation of the higher attention weights of input features F4, F6 at time t4 to the low strictness value 236 at time t4, the security policy correlation engine 124 can make a determination that a second subset (F4 and F6) of the input features F1 to F6 contributed more to the decision to select the more lenient security policy at time t4 as compared to the remainder (F1, F2, F3, and F5) of the input features F1 to F6.

The input features with higher attention weights at a given time constitute local perturbations that contributed to the prediction of the security policy at the given time by the machine learning model 114. The identified subsets of input features along with their respective time points are added to explanation information (e.g., 130 in FIG. 1) that can be provided to a target entity to perform further actions based on the explanation information. Generally, the explanation information may include multiple entries, where each entry includes an identified subset of input features, a time point associated with the identified subset of input features, and the value of S(t) at the time point.

In addition to identifying a subset of input features that contributed more to a predicted security policy at the given time, an entry in the explanation information can further include information of a degree of contribution of each input feature of the subset of input features to the predicted security policy. The degree of contribution of a particular input feature to the predicted security policy can be represented by the attention weight assigned to the particular input feature. Thus, the explanation information can include the attention weights assigned to the identified subset of input features that contributed to the predicted security policy at the given time. In other examples, the degree of contribution of a particular input feature to the predicted security policy can be a measure computed based on the attention weight assigned to the particular input feature and other attention weight(s) assigned to other input feature(s) in the identified subset of input features.

For example, assuming the identified subset of input features includes Fx, Fy, and Fz, the measure for input feature Fj (j=x, y, or z) can be a relative percentage contribution computed as follows:

$$Fj = AW ( 1 ) / ( AW ( x ) + AW ( y ) + AW ( z ) ) , \qquad ( 1 )$$

where AW(j) is the attention weight of input feature Fj, AW(x) is the attention weight of input feature Fx, AW(y) is the attention weight of input feature Fy, and AW(z) is the attention weight of input feature Fz.
Corroboration of Explanation Provided from the Model Explanation System

In some examples, the explanation information 130 provided by the model explanation system 132 can be corroborated using additional systems. Corroboration of the explanation information 130 from the model explanation system 132 may be useful in instances where the machine learning model 114 may suffer from inaccuracies, especially when the machine learning model 114 is first deployed for a given network environment and thus the machine learning model 114 may not have been fully trained based on specific training data for the given network environment.

For example, an analysis system 150 (FIG. 1) (implemented with one or more computers) may be used to identify potential vulnerabilities and threats in the network environment 104. As examples, the analysis system 150 may apply entity matching, which links data points related to the same user, device, or program across different data points. In further examples, the analysis system 150 may apply event correlation, which identifies relationships between security events occurring in different systems or at different times. In other examples, the analysis system 150 can apply anomaly detection, which identifies deviations from normal behavior patterns that might indicate a potential attack. The results produced by the analysis system 150 may include a presentation of threats over time. The results from the analysis system 150 may be compared to the explanation information 130 from the model explanation system 122 to determine whether the results align with the explanation information 130. For example, the results from the analysis system 150 may indicate a spike in malware at a particular time point (as compared to a baseline model of malware activity). If the explanation information 130 also indicates that an input feature representing the malware contributed to a stricter security policy predicted by the machine learning model 114 at the particular time point, then an administrator would be able to confirm that the explanation information 130 is accurate.

The baseline model of malware activity (or any other baseline model of attributes representing a behavior of interest) can be produced by the analysis system 150 by continually monitoring the attributes in the network environment 104 over time to establish normal behavior which can be used as the baseline model. Deviations from the baseline model (such as the spike noted above) indicate potential threats. For example, logins to a user account may typically occur during business hours from a specific location. A sudden login attempt at night from a different country may be an anomaly. As another example, an application usually transfers a small amount of data daily. A sudden spike in data transfer volume may be suspicious. As a further example, a device on a network normally communicates with a restricted set of IP addresses. Communications with unknown IP addresses may be a sign of malware infection.

The following example technique can be used to corroborate the explanation information 130 from the model explanation system 122. The example technique may be performed by the analysis system 150. The analysis system 150 detects anomalous attributes by generating thresholds of attributes based on a baseline model. Values of attributes being analyzed can be compared to the generated thresholds to determine which attribute values are considered anomalous. An alert can be generated if an attribute value violates a generated threshold.

In addition to comparing attribute values to generated thresholds as noted above, the analysis system 150 can also detect an anomaly by comparing attribute values a static (or precomputed) threshold. An alert can be generated if an attribute value violates a static threshold.

The analysis system 150 detects anomalous differences by comparing the attributes being analyzed with other entities (including attributes) in a peer security context. A peer security context can specify a list of additional attributes to which attributes being analyzed are compared. The comparison can indicate whether an anomaly is present, and if so, an alert can be issued by the analysis system 150.

Based on one or more alerts issued above, the analysis system 150 can generate a trust level for a given entity (e.g., a user, a device, a program, a network, or any other entity). A trust level can be based on types of alerts generated. A lower trust level is indicated if high severity alerts are generated, which are alerts indicating critical security events (e.g., unauthorized access attempts, suspicious financial activity, etc.) will significantly decrease trust. On the other hand, a higher trust level is indicated if low severity alerts are generated, which are less critical alerts (e.g., failed login attempts due to typographical entries by users) with smaller impact, especially if infrequent. A trust level may also be based on the frequency of alerts. Frequent occurrences of any type of alert, even low severity ones, can suggest potential issues and gradually erode trust.

The trust level produced by the analysis system 150 at a given time point can be compared to the explanation information 130 to determine whether the trust level from the analysis system 150 corroborates a predicted security policy from the machine learning model 114 at a particular time point. If so, then the analysis system 150 is able to corroborate that the explanation information 130 is accurate.

The combination of alerts generated by the analysis system 150 and a change in security policy predicted by the machine learning model 114 (especially a change to a stricter security policy) may indicate that a root cause of the change in security policy is an attack or vulnerability in the network environment 104.

### FURTHER EXAMPLES

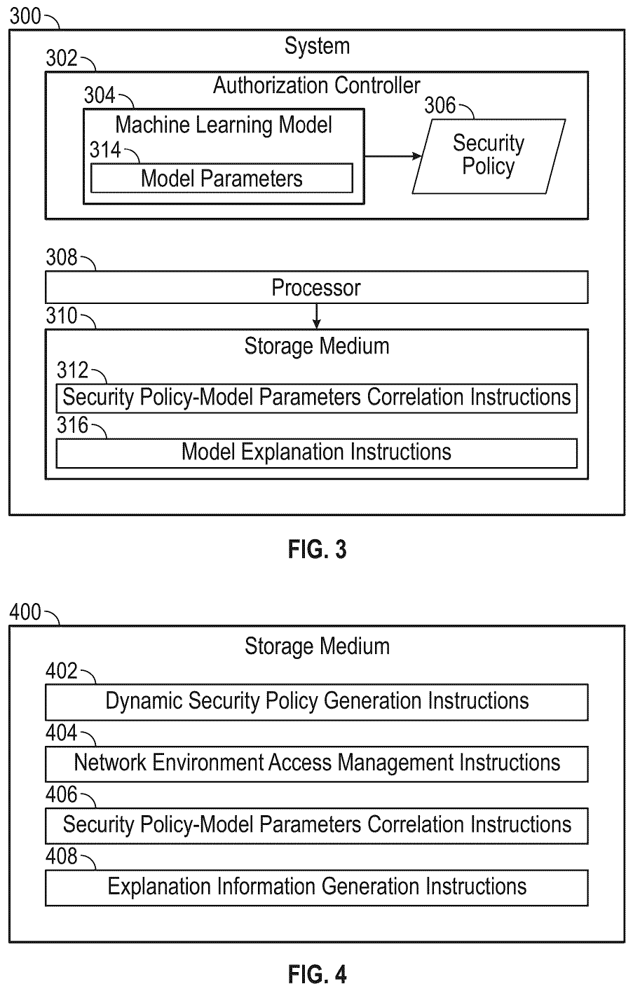

FIG. 3 is a block diagram of a system 300, which may be implemented using one or more computers. The system 300 includes an authorization controller 302 that includes a machine learning model 304. The authorization controller 302 manages access control to a network environment by a client device based on input features to the machine learning model 304. An example of the authorization controller 302 is the authorization controller 112 of FIG. 1, and an example of the machine learning model 304 is the machine learning model 114 in FIG. 1. The input features include user information of a user of the client device (e.g., the user information represented by Table 1), device information representing the client device (e.g., the device information represented by Table 2), and network information representing a network used by the client device (e.g., the network information represented by Table 4). The machine learning model 304 when executed by the authorization controller 302 generates a security policy 306 used by the authorization controller 302 in managing the access control of the network environment. The security policy represents security controls to be used by the authorization controller 302 in managing the access control of the network environment. In some examples, the security controls include one or more of: an intrusion detection and protection control, an anti-malware control, a data loss prevention control, a firewall control, a cryptographic configuration, or a data inspection configuration.

The system 300 further includes a hardware processor 308 (or multiple hardware processors). The system 300 also includes a storage medium 310 storing machine-readable instructions executable on the hardware processor to 308 to perform various tasks. In some examples, the hardware processor 308 and the storage medium 310 are part of the model explanation system 122 of FIG. 1.

A hardware processor can include a microprocessor, a core of a multi-core microprocessor, a microcontroller, a programmable integrated circuit, a programmable gate array, or another hardware processing circuit. Machine-readable instructions executable on a hardware processor can refer to the instructions executable on a single hardware processor or the instructions executable on multiple hardware processors.

The machine-readable instructions include security policy-model parameters correlation instructions 312 to correlate the security policy 306 to model parameters 314 set by the machine learning model 304 in generating the security policy 306. The correlation can correlate values of the model parameters 314 to strictness measures (e.g., S(t) above) representing the strictness of security policies generated by the machine learning model 304.

The machine-readable instructions include model explanation instructions 316 to use the correlation to indicate which of the input features contributed to the security policy 306 generated by the machine learning model 304. An input feature identified as contributing to the security policy 306 is associated with a model parameter having a value indicating a larger contribution than another model parameter.

In some examples, the authorization controller is part of a network edge device (e.g., 102 in FIG. 1).

In some examples, the machine learning model 304 is a transformer model, and the model parameters 314 include a plurality of attention weights set by the transformer model.

In some examples, each respective attention weight of the plurality of attention weights is associated with a respective input feature of the input features, and a value of the respective attention weight indicates a level of contribution of the respective input feature to the generation of the security policy 306 by the transformer model.

In some examples, the machine-readable instructions can generate explanation information (e.g., 130 in FIG. 1) that identifies a subset of the input features that contributed to the security policy 306 generated by the machine learning model (e.g., the transformer model).

In some examples, each respective model parameter of the model parameters 314 (e.g., attention weights) is associated with a respective input feature of the input features. A value of a respective model parameter 314 (e.g., attention weight) indicates a level of contribution of the respective input feature to the generation of the security policy by the machine learning model 304. The machine-readable instructions can generate explanation information that identifies a subset of the input features that contributed to the security policy 306 generated by the machine learning model 304. The explanation information includes a contribution value based on a value of a model parameter 314 for a given input feature of the subset of the input features, the contribution value indicating a degree of contribution of the given input feature to the security policy 306 generated by the machine learning model 304.

In some examples, the machine-readable instructions can corroborate the explanation information based on further analysis using monitored attributes in the network environment. The machine-readable instructions to corroborate may be part of the analysis system 150 of FIG. 1, for example.

In some examples, the input features are part of one or more input vectors to the machine learning model 304, and the security policy 306 generated by the machine learning model 304 includes a security policy vector having security policy parameters representing respective security controls to be applied by the authorization controller 302.

In some examples, the user information includes one or more of first distance information indicating a distance of the user from an access device that provides access to the network, or second distance information indicating a distance of the user from a prior location at which the user logged in to the network environment, or third distance information indicating a distance of the user from a location at which prior connections of the user to the network environment were observed. Examples of such user information are included in Table 1.

In some examples, the user information further includes information of an authentication technique used by the user, and/or information of bandwidth consumption of the network environment by the user. Examples of such further user information are included in Table 1.

In some examples, the device information includes one or more of information of a reputation of a supplier (e.g., manufacturer) of the client device, information of a program (e.g., a host OS or system firmware) in the client device, information of any security module (e.g., HSM or TPM) in the client device, or information of a deployment of an application invoked by the client device. Examples of such device information are included in Table 2.

In some examples, the network information includes one or more of a network address of the client device, health information of the network, security information indicating a security threat level in the network, or a network tag of the client device. Examples of such network information are included in Table 4.

In some examples, the input features further include program information including one or more of information of a category of a website accessed by the client device, score information based on a browsing history of the client device, a program category of a program in the client device, or reputation information based on a geolocation of the program. Examples of such program information are included in Table 3.

FIG. 4 is a block diagram of a non-transitory machine-readable or computer-readable storage medium 400 storing machine-readable instructions that upon execution cause a system to perform various tasks.

The machine-readable instructions in the storage medium 400 include dynamic security policy generation instructions 402 to generate, using a machine learning model in an authorization controller that manages access control to a network environment by a client device, a dynamic security policy. The dynamic security policy generated by the machine learning model is based on input features to the machine learning model, the input features including user information of a user of the client device, device information representing the client device, and network information representing a network used by the client device.

The machine-readable instructions in the storage medium 400 include network environment access management instructions 404 to manage, by the authorization controller, access of the network environment in response to access requests from the client device. The access control uses security controls specified by the security policy.

The machine-readable instructions in the storage medium 400 include security policy-model parameters correlation instructions 406 to correlate the security policy to model parameters set by the machine learning model in generating the security policy. The correlation can correlate values of model parameters to strictness measures representing strictness of security policies.

The machine-readable instructions in the storage medium 400 include explanation information generation instructions 408 to generate, based on the correlation, explanation information indicating a subset of the input features contributing to the security policy generated by the machine learning model.

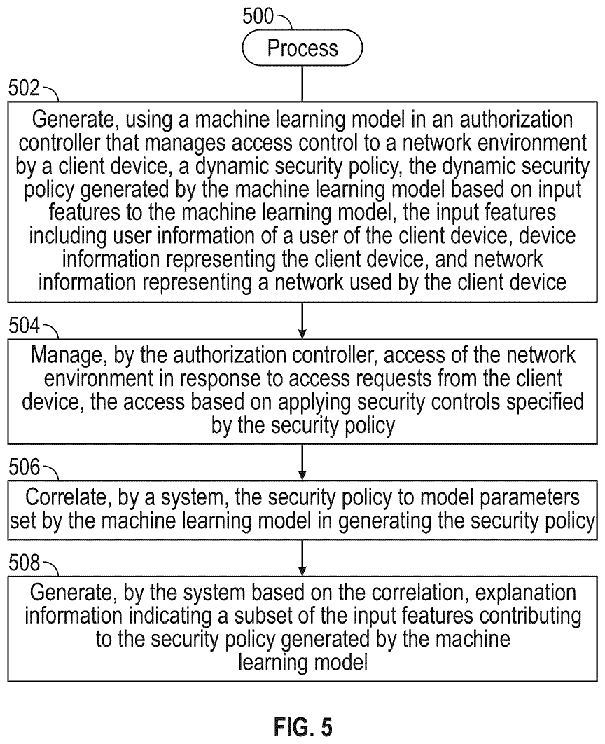

FIG. 5 is a flow diagram of a process 500 according to some examples. The process 500 may be performed by the authorization controller 112 and the model explanation system 122 of FIG. 1, for example.

The process 500 includes generating (at 502), using a machine learning model in an authorization controller that manages access control to a network environment by a client device, a dynamic security policy, the dynamic security policy generated by the machine learning model based on input features to the machine learning model, the input features including user information of a user of the client device, device information representing the client device, and network information representing a network used by the client device.

The process 500 includes managing (at 504), by the authorization controller, access of the network environment in response to access requests from the client device, the access based on applying security controls specified by the security policy.

The process 500 includes correlating (at 506), by a system, the security policy to model parameters set by the machine learning model in generating the security policy. The correlation, which may be performed by the model explanation system 122 of FIG. 1, for example, can correlate values of model parameters to strictness measures representing strictness of security policies generated by the machine learning model.

The process 500 includes generating (at 508), by the system based on the correlation, explanation information indicating a subset of the input features contributing to the security policy generated by the machine learning model.

As used here, an “engine” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, an “engine” can refer to a combination of one or more hardware processing circuits and machine-readable instructions (software and/or firmware) executable on the one or more hardware processing circuits.

A “client device” can refer to any electronic device capable of issuing access requests to access a network environment. Examples of client devices include computers (e.g., desktop computers, notebook computers, tablet computers, server computers, or other types of computers), smartphones, game appliances, Internet of Things (IoT) devices, household appliances, vehicles, or other types of electronic devices.

A “storage device” can refer to any device capable of storing data, such as a disk-based storage device, a solid state drive, or a memory device.

A storage medium (e.g., 310 in FIG. 3 or 400 in FIG. 4) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A system comprising:
an authorization controller comprising a machine learning model to manage access control to a network environment by a client device based on input features to the machine learning model, the input features comprising user information of a user of the client device, device information representing the client device, and network information representing a network used by the client device, wherein the machine learning model when executed by the authorization controller generates a security policy used by the authorization controller in managing the access control;
a processor; and
a non-transitory storage medium comprising instructions executable on the processor to:
correlate the security policy to model parameters set by the machine learning model in generating the security policy; and
use the correlation to indicate which of the input features contributed to the security policy generated by the machine learning model.

2. The system of claim 1, wherein the authorization controller is part of a network edge device.

3. The system of claim 1, wherein the machine learning model is a transformer model, and the model parameters comprise a plurality of attention weights set by the transformer model.

4. The system of claim 3, wherein each respective attention weight of the plurality of attention weights is associated with a respective input feature of the input features, and wherein a value of the respective attention weight indicates a level of contribution of the respective input feature to the generation of the security policy by the transformer model.

5. The system of claim 4, wherein the instructions are executable on the processor to:
generate explanation information that identifies a subset of the input features that contributed to the security policy generated by the transformer model.

6. The system of claim 5, wherein the explanation information includes a contribution value based on the attention weight for a given input feature of the subset of the input features, the contribution value indicating a degree of contribution of the given input feature to the security policy generated by the transformer model.

7. The system of claim 1, wherein each respective model parameter of the model parameters is associated with a respective input feature of the input features, wherein a value of a respective model parameter indicates a level of contribution of the respective input feature to the generation of the security policy by the machine learning model, and wherein the instructions are executable on the processor to:
generate explanation information that identifies a subset of the input features that contributed to the security policy generated by the machine learning model, wherein the explanation information includes a contribution value based on a value of a model parameter for a given input feature of the subset of the input features, the contribution value indicating a degree of contribution of the given input feature to the security policy generated by the machine learning model.

8. The system of claim 1, wherein the instructions are executable on the processor to:
generate explanation information that identifies a subset of the input features that contributed to the security policy generated by the machine learning model; and
corroborate the explanation information based on further analysis using monitored attributes in the network environment.

9. The system of claim 1, wherein the input features are part of one or more input vectors to the machine learning model, and wherein the security policy generated by the machine learning model comprises a security policy vector comprising security policy parameters representing respective security controls to be applied by the authorization controller.

10. The system of claim 1, wherein the user information comprises one or more of first distance information indicating a distance of the user from an access device that provides access to the network, or second distance information indicating a distance of the user from a prior location at which the user logged in to the network environment, or third distance information indicating a distance of the user from a location at which prior connections of the user to the network environment were observed.

11. The system of claim 1, wherein the user information comprises one or more of information of an authentication technique used by the user, or information of bandwidth consumption of the network environment by the user.

12. The system of claim 1, wherein the device information comprises one or more of information of a reputation of a supplier of the client device, information of a program in the client device, information of any security module in the client device, or information of a deployment of an application invoked by the client device.

13. The system of claim 1, wherein the network information comprises one or more of a network address of the client device, health information of the network, security information indicating a security threat level in the network, or a network tag of the client device.

14. The system of claim 1, wherein the input features further comprise program information comprising one or more of information of a category of a website accessed by the client device, score information based on a browsing history of the client device, a program category of a program in the client device, or reputation information based on a geolocation of the program.

15. The system of claim 1, wherein the security policy represents security controls to be used by the authorization controller in managing the access control of the network environment.

16. The system of claim 15, wherein the security controls comprise one or more of: an intrusion detection and protection control, an anti-malware control, a data loss prevention control, a firewall control, a cryptographic configuration, or a data inspection configuration.

17. A non-transitory machine-readable storage medium comprising instructions that upon execution cause a system to:
generate, using a machine learning model in an authorization controller that manages access control to a network environment by a client device, a dynamic security policy, the dynamic security policy generated by the machine learning model based on input features to the machine learning model, the input features comprising user information of a user of the client device, device information representing the client device, and network information representing a network used by the client device;
manage, by the authorization controller using the security policy, access of the network environment in response to access requests from the client device;
correlate the security policy to model parameters set by the machine learning model in generating the security policy; and
generate, based on the correlation, explanation information indicating a subset of the input features contributing to the security policy generated by the machine learning model.

18. The non-transitory machine-readable storage medium of claim 17, wherein the machine learning model comprises a transformer model, the model parameters comprise respective attention weights that are associated with the input features, and the explanation information associates the subset of input features with a contribution value based on the attention weight associated with a given input feature of the subset of input features, the contribution value indicating a degree of contribution of the given input feature to the security policy generated by the transformer model.

19. A method comprising:
generating, using a machine learning model in an authorization controller that manages access control to a network environment by a client device, a dynamic security policy, the dynamic security policy generated by the machine learning model based on input features to the machine learning model, the input features comprising user information of a user of the client device, device information representing the client device, and network information representing a network used by the client device;
managing, by the authorization controller, access of the network environment in response to access requests from the client device, the access based on applying security controls specified by the security policy;
correlating, by a system, the security policy to model parameters set by the machine learning model in generating the security policy; and
generating, by the system based on the correlation, explanation information indicating a subset of the input features contributing to the security policy generated by the machine learning model.

20. The method of claim 19, wherein the model parameters are associated with the input features, and the explanation information associates the subset of input features with a contribution value based on a value of the model parameter associated with a given input feature of the subset of input features, the contribution value indicating a degree of contribution of the given input feature to the security policy generated by the machine learning model.
